(19) United States
(12) Patent Application Publication
(10) Pub. No.: US 2008/0274646 A1
(43) Pub. Date: Nov. 6, 2008

(54) ETHERNET CONNECTORS

(75) Inventors: Ronald SCHOOP, Hainburg (DE); Wanda REISS, Sudbury, MA (US)

Correspondence Address: DENNISON, SCHULTZ & MACDONALD, 1727 KING STREET, SUITE 105, ALEXANDRIA, VA, 22314, US

(73) Assignee: SCHNEIDER ELECTRIC GMBH, Seligenstadt (DE)

(21) Appl. No.: 11/948,140

(22) Filed: Nov. 30, 2007

Related U.S. Application Data
(60) Provisional application No. 60/915,972, filed on May 4, 2007.

(51) Int. Cl. H01R 13/66

(52) U.S. Cl. 439/620.23

(57) ABSTRACT

A modular ethernet-connector includes a jack (70) as part of a device (62) such as industrial automation device with embedded Ethernet connectivity (66), and a corresponding plug, the plug (94) being part of a WLAN-stick (82) which includes an embedded Ethernet-WLAN-Bridge (84).

This application claims the benefit of U.S. Provisional Application Ser. No. 60/915,972 filed May 4, 2007, the contents of which are incorporated herein by reference.

### FIELD OF THE INVENTION

The invention relates to a Modular Ethernet-Connector, comprising a jack as part of a device such as industrial automation device with embedded Ethernet connectivity and a corresponding plug to connect the device with the Ethernet.

### BACKGROUND OF THE INVENTION

Devices in Industrial Automation (IA) markets have been traditionally connecting using industrial protocols running over industrial fieldbuses. In recent years, new trend evolved where the traditional fieldbuses are being replaced by industrial protocols 10, 12 running on standard Internet Protocols (IP) 14 16, commonly called TCP/IP protocols, and using standard Internet infrastructure, as shown in FIG. 1. The most prevalent has been Ethernet twisted Copper pair infrastructure. As a result, many IA devices use standard RJ45 Ethernet connectors.

Furthermore, progress made in wireless Internet connectivity made it attractive for Industrial Automation market. For example, the Ethernet (IEEE 802.3) and WiFi (IEEE 802.11) networks may be easily combined into a single system currying Industrial protocols 10, 12 such as Modbus TCP or EtherNet/IP.

FIG. 1 shows these example industrial protocols 10, 12 placed interchangeably on Ethernet 18, and WiFi 22 link layers. Other than WiFi WLANs can be developed.

Traditionally WLAN connectivity is being achieved by:

A: Integrating WLAN circuits and antenna into a device. Disadvantage: significant effort in designing a new device and the entire device must be exchanged when connecting to LAN or WLAN.

B: Using a WLAN USB stick. Disadvantage: only few Industrial Automation devices offer an USB port and the port is used to configure and diagnose rather then for control data. That would require architectural modifications to the device and complex device configuration when switching between LAN and WLAN.

### SUMMARY OF THE INVENTION

The invention relates to an enhancement to Ethernet-enabled Industrial Automation (IA) devices to interchangeably connect into them a standard Local Area Networks (LAN) Ethernet cable or a Wireless LAN (WLAN) stick, and a WLAN stick with RJ45 interface and a bridge Ethernet-WLAN functionality in it.

Using separate IA device for LAN and WLAN may create barriers to acceptance as a result of real or perceived differences in the device's application functionality. Capability of adapting the same Ethernet-enabled device to a new wireless connectivity rather than replacing it with a separate device would eliminate such concerns.

The object of this invention is a smart upgrade to an Ethernet IA device and providing an Ethernet WLAN stick. This WLAN stick connects to the IA device's Ethernet port interchangeably with the Ethernet cable and behaves as a virtual cable: the rest of the device functionality and the network properties remain unchanged. A user simply chooses between an Ethernet cable and the Ethernet WLAN stick.

The RJ45 WLAN stick has none of the above disadvantages: Most of the IA devices offer Ethernet connectivity via RJ45 connectors, the LAN and WLAN are in the same control data path, and with this invention the same device accepts an Ethernet cable or the RJ45 WLAN stick.

For the WLAN stick to operate as an Ethernet device's bridge to the WLAN network interchangeably with an Ethernet cable, it gets power from the IA device through the RJ45 connector. In this invention we are upgrading an IA device by adding power to spare pins of the standard RJ45 connector and we are providing a WLAN stick with RJ45 interface and an Ethernet-WLAN bridge functionality in it. The stick is drawing power from the RJ45 pins.

Every IA device with the new RJ45 connector can be easily upgraded to WLAN.

An alternative option may be to generate in the stick the power supply by using the signals of the pins of the Ethernet signals to supply a switching power supply, generating inside the stick the needed power supply.

A further prepared embodiment relates to an RJ45-connector, comprising a jack with pins J1-J8 as part of a device such as industrial automation device with embedded communication connectivity module and/or industrial automation device processor, a corresponding plug with pins P1-P8, whereby the plug is part of a radio-communication-stick which comprise an embedded radio-communication-bridge, and that a spare pin and/or a signal pin are used for carrying power from the device to the radio-communication-stick.

The invention relates also to a RJ45-connector, whereby the plug being part of a memory-stick comprising an embedded memory.

### BRIEF DESCRIPTION OF THE DRAWINGS

FIG. 1: Industrial protocols using Ethernet and WiFi as link layers

FIG. 2: Industrial Automation connectivity system combining Ethernet and WiFi infrastructure

FIG. 3: Industrial Automation system using WLAN for cable redundancy

FIG. 4 a, b: (a): Power injection into RJ45 in the Industrial Automation device with Ethernet connectivity and
(b): Block diagram of Ethernet-WiFi bridge or WiFi Access Point hardware

FIG. 5: Alternative power injection scheme into RJ45

FIG. 6: Delivering power over standard Ethernet cables

FIG. 7 a, b: (a): An Ethernet connector with grounded spare wires, and (b): PoE-enabled Ethernet connector

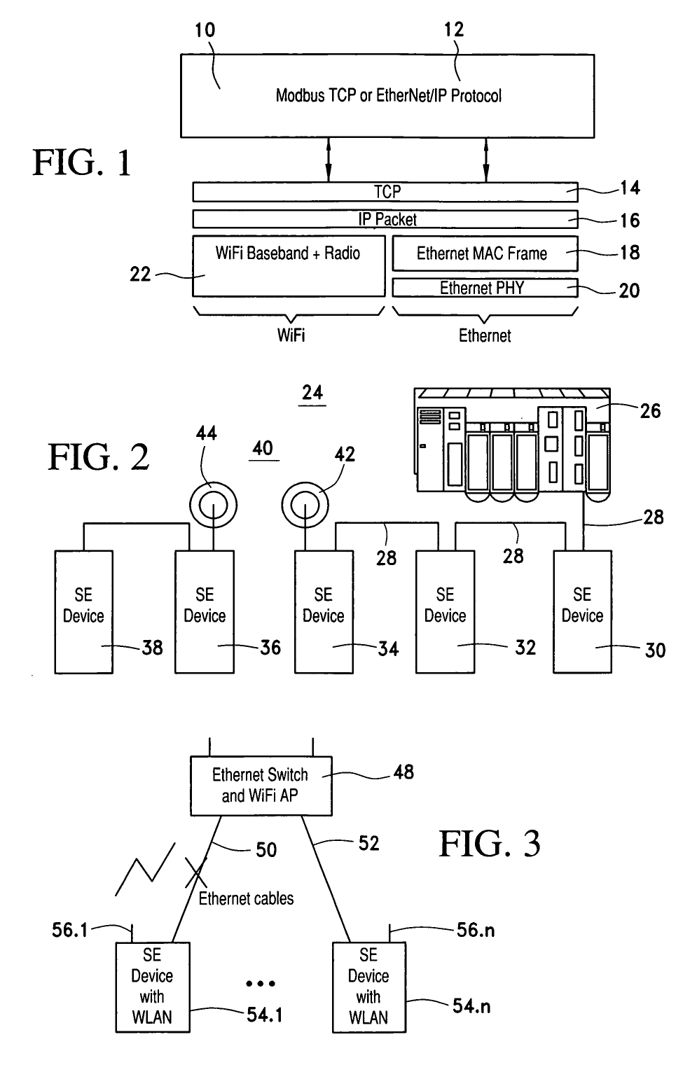

### DETAILED DESCRIPTION OF SOME NON-LIMITING EMBODIMENTS OF THE INVENTION

FIG. 2 shows a simple example of an IA system 24 providing combined Ethernet and WLAN connectivity at the device level. A control unit 26 is connected to SE Devices 30, 32, 34 via a LAN-connection. Further SE Devices 36, 38 are coupled to control unit 26 via a WLAN connection, said SE Devices 34, 36 each having a WLAN unit 42, 44.

The same device that is typically used in an Ethernet Daisy Chain (DC) topology may occasionally need to be extended to connect wirelessly over one or more segments of the chain.

FIG. 3 shows another IA application comprising an Ethernet switch with WiFi 48 which is connected over Ethernet cables 50, 52 to SE Devices 54.1-54.n with WLAN 56.1-56.n. The WLAN 56.1-56.n serves as a redundancy connection.

FIG. 4 a shows purely in principal the design of an industrial automation device 62 with an Ethernet connectivity module 64. The Ethernet connectivity module 64 comprises an Ethernet connectivity processor 66 with memories being connected to jacks 70, 72 like RJ45 male connectors via an Ethernet switch 68. In addition the Ethernet connectivity module 64 comprises a power supply 74, that is connected to a power supply 76 of the industrial automation device 62. Finally, the Ethernet connectivity module 64 is connected to an industrial automation device processor 80 via a serial or parallel port 78.

For connecting the industrial automation device 64 to a WLAN a WLAN-stick 82 is proposed, which comprises an embedded Ethernet-WLAN-bridge 84. This comprises a processor 86 with assigned storage units coupled on the one hand to a WiFi-module 88 with antenna unit 90 and on the other hand to an Ethernet-module 92. Said processor 86 performs bridge functionality of repackaging between Ethernet- and WiFi-frames, whereby the Ethernet-module 92 is connected to a plug 94, preferably an RJ45 female connector but male connector and a male-female adapter could also be used.

This WLAN-stick 82 connects to the device Ethernet port 70 interchangeably with the Ethernet cable and behaves as a virtual cable: the rest of the device functionality and the network properties remain unchanged. A user simply chose between an Ethernet cable and the WLAN-stick 82.

For the Ethernet-stick 82 to operate as an Ethernet device bridge to the WiFi-network, it must get power from the device through the RJ45 connector 70. For this purpose, a pin 96 of the connector 70 is connected with a power supply preferably with the power supply 76 of the industrial automation device 62 in the embodiment described a distribution voltage of 3.3 V. Furthermore, a pin 98 is connected to ground. Correspondingly, a pin 100 of the RJ45 connector 94 of the WLAN-stick 82 is connected to ground and a pin 102 leads to an internal power supply 104, that provides several distribution voltages for feeding the Ethernet-WiFi-bridge 84.

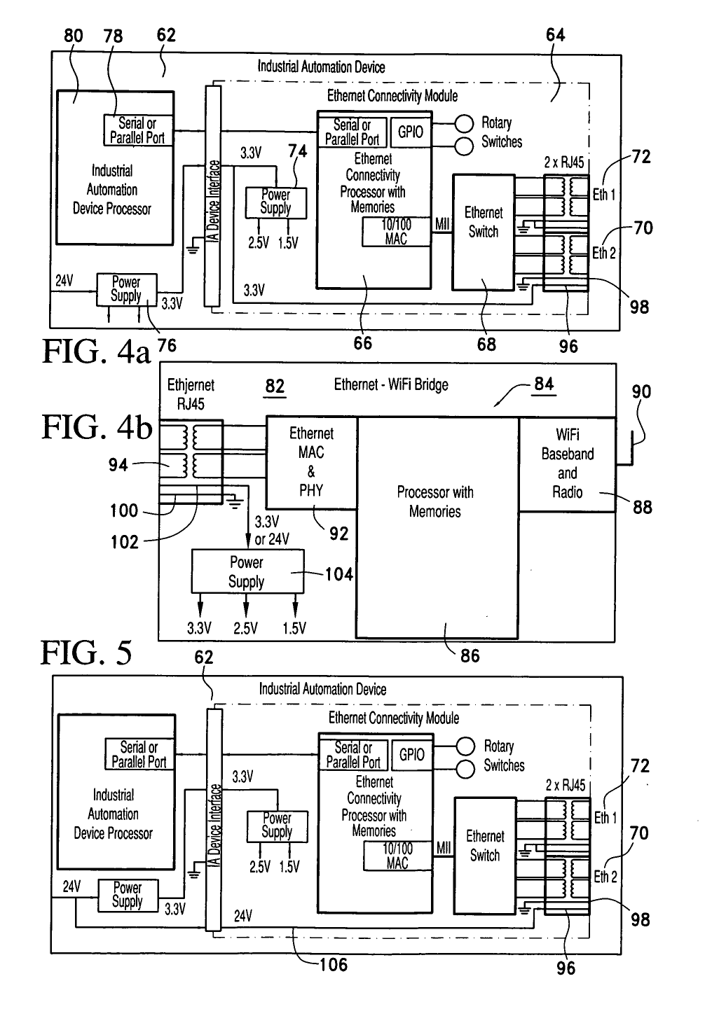

FIG. 5 shows an alternative embodiment of the industrial automation device 62 that essentially has the same design as the one described in FIG. 4a. However, pin 96 of the RJ45 connector 70 is connected to device's input voltage 24V via a line 106. Other values than 3.3V or 24V could be supplied to the RJ45 connector.

### Smart Upgrade Connector

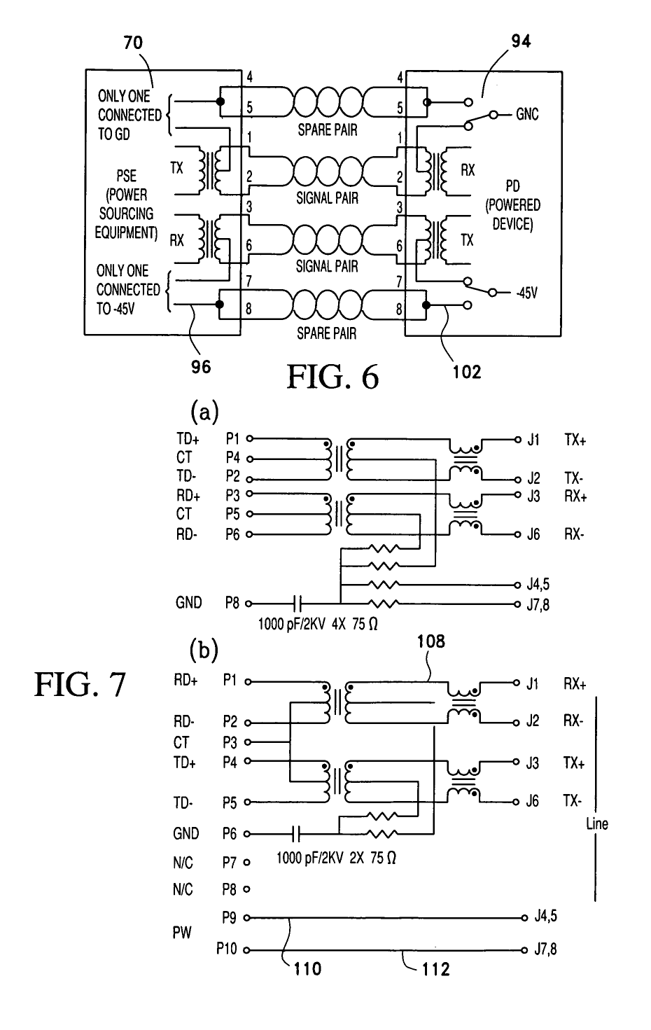

The RJ45 male connector 70 embedded in the IA device 62 must serve interchangeably the WLAN stick 82 as well as a standard CAT 5 twisted pair Ethernet cable, and thus it has to accept standard size mating connector and provide standard pin assignment. In the standard Ethernet RJ45 for 10 Mbps and 100 Mbps rates, the pins 1, 2, 3 and 6 are signal pins and the pins 4, 5, 7 and 8 are spare pins as shown in FIG. 6. (Note that 1000 Mbps rates use all pins with no spare pins.) All pins could be used to carry power from the IA device 62 to the Ethernet WLAN stick 82, as described in the Power over Ethernet IEEE 802.3af standard. In that standard the device 62 injecting power into the RJ45 connector 70 is called the Power Sourcing Equipment (PSE) and typically indicates an Ethernet switch or router. The power drawing device is called the Powered Device (PD) and typically indicates IP phone, camera, set-top box or WiFi Access Point (AP). The IEEE standard specifies 48V Direct Current (DC) as a standard voltage level. FIG. 6 shows delivering power over standard Ethernet cables.

The spare wire scheme is preferred as it is the least expensive and results in the simplest implementation, but all wires could be used for transporting the power, as described in the IEEE standard. The Smart Upgrade system of this invention does not use the PoE standard; it uses standard RJ45 pin assignments for the spare wire scheme. The IA devices 62 use male RJ45 connectors 70. The Ethernet WLAN-stick 82 uses female RJ45 connector or a male connector 94 and an adapter.

### Smart Upgrade IA Device

The IEEE PoE standard requires 48V on the connector. The PoE standard attempts to maximize the power available for the end devices, to about 12 W and accounts for the voltage drop along the long Ethernet cabling.

There is only one end-device and there is no long Ethernet cabling in the proposed Smart Upgrade system. The Ethernet WLAN-stick 82 requires no more than 2 to 3 W and voltage drop on a connector alone is small. In addition, the Industrial Automation devices are typically supplied from the 24V DC power supplies and 48V is not readily available. Therefore, 24V on the connector is a better option for this market. Another viable option is a highest voltage required by the Ethernet WLAN-stick 82, which is 3.3V or 5V DC. Such a power supply 76 already exists in the IA devices 62 as it is used by electronic chips. FIGS. 4a and 5 show viable for IA devices power injecting schemes.

The power injecting at the 3.3V or 5V level could be easily part of the Ethernet IA devices 62 with minimal or none additional cost to the devices. The 3.3V or 5V level would also result in the lower cost of power supply 104 circuitry inside of the Ethernet WLAN stick 82. All IA devices 62 with Ethernet connectivity could be designed to provide power to the spare RJ45 pins.

A voltage sensing functionality and a signature detection could be added to the system if needed.

The IA devices 62 typically use RJ45 connectors 70, 72 with embedded magnetics. Such connectors often connect spare wires 4, 5, 7, 8 together inside of the connector enclosure making them inaccessible to the board designer, as shown in FIG. 7 (a). This would not allow retrofitting existing Ethernet devices 62 to power Ethernet WLAN-sticks 82. However, new devices could use PoE-enabled connectors as shown in FIG. 7 (b). In this example the PoE-enabled connectors 108 have two more pins 110, 112 and thus could not be simply dropped into the old footprint. The redesign effort would be small though, as the outline of both connectors is identical.

### Smart Upgrade Removable WLAN Stick

The Ethernet-WLAN bridge 82 receives the power from the Ethernet device 62 and provides hardware 84 and firmware for the bridge functionality.

A typical switching 24 VDC or 3.3-5 VDC power supply 104 could be used. The 3.3V-5V design is preferable for lower power dissipation, smaller physical size and a lower cost. This power supply 104 is assumed to generate all other voltage levels necessary for active electrical components of the stick. A switching power supply 104 is recommended to keep power supply of the Ethernet WLAN stick's power independent of the voltage drop on the connectors.

Several bridge implementations are available. One of possibilities would be to use WiFi Access Point (AP) hardware 84, which is identical to that of the Ethernet-WiFi bridge.

The bridge hardware typically combines WiFi and network processors and eliminates redundant circuitry. The processor 86 performs the bridge functionality of repackaging between Ethernet and WiFi frames. It also provides an error checking, any WiFi related security functionality, and the simplest modes of WiFi operation: the point-to-point communication in an ad-hock mode. Not all AP firmware functionality is necessary.

An example is PRISM Access Point Developers Kit readily available for developers. It offers drivers and WiFi functionality for Linux RTOS and stack. Only ad-hock functionality would be required for the Smart Upgrade stick which is a subset of fully fledged Access Point functionality.

Note that other than daisy chain network topologies, such as star or mesh could be constructed. The star topology could be used with one of existing WiFi routers or stand-alone switches.

### Mechanical Considerations

The Ethernet stick 82 is flimsy as opposed to much sturdier USB stick. The male-female RJ45 adapter could be combined with the fixture to make the stick sturdy. Another option is to use a short Ethernet cable.

What is claimed is:

1. Modular Ethernet-Connector (62, 82), comprising:
a jack (70) as part of a device (62) such as industrial automation device with embedded Ethernet connectivity (66), and
a corresponding plug,
wherein the plug (94) is part of a WLAN-stick (82) which comprise an embedded Ethernet-WLAN-Bridge (84).

2. Modular Ethernet-Connector according to claim 1, wherein the Ethernet-WLAN-Bridge (84) comprise a WiFi-Module (88), an Ethernet-Module (92) and a processor (86) to perform the bridge functionality of repackaging between Ethernet- and WiFi-frames, whereby the Ethernet-Module (92) is connected with the plug.

3. Modular Ethernet-Connector according to claim 1, wherein the WLAN-stick (82) comprise a power supply (104), which input is connected to a power-pin (102) of the plug (94) to get power from a device power supply (76) or an external power supply and which output is connected to the Ethernet-WLAN-Bridge (84).

4. Modular Ethernet-Connector according to claim 3, wherein the power supply (104) is designed preferably as switching power supply preferably with a input voltage in the range of 3.3 VDC to 24 VDC and an output voltage in the range of 1.5 VDC to 5 VDC.

5. Modular Ethernet-Connector according to claim 1, wherein the Ethernet-Connector (70, 94) is a modified male or female RJ45-connector, whereby spare pins (4, 5; 7, 8) and/or signal pins (1, 2, 3, 6) are used to carry power from the device (62) to the WLAN-stick (82).

6. Modular Ethernet-Connector according to claim 1, wherein the Ethernet-Connector (70, 94) is a PoE-enabled RJ45-connector.

7. Modular Ethernet-Connector according to claim 1, wherein the jack (70) is connected via a short Ethernet-cable to Ethernet-WLAN-Bridge.

8. Modular Ethernet-Connector according to claim 1, wherein a male/female RJ45-connector (70, 94) is combined with a fixture-means such as magnetic or locking means.

9. Modular Ethernet-Connector according to claim 1, wherein the jack (70) accepts interchangeably Ethernet-cable or WLAN-stick (82).

10. Modular Ethernet-Connector according to claim 1, wherein the WLAN-stick (82) comprises a separate power supply like storage battery or battery or external power supply.

11. Modular Ethernet-Connector according to claim 1, wherein the switching power supply is connected to signal pins to generate in the stick the power supply by using the signals of the pins of the Ethernet signals.

12. RJ45-connector, comprising a jack (70) with pins (J1-J8) as part of a device (62) such as industrial automation device with embedded communication connectivity module (64) and/or industrial automation device processor (80), and a corresponding plug (94) with pins (P1-P8),
wherein the plug (94) is part of a radio-communication-stick (82) which comprises an embedded radio-communication-bridge (84), and that a spare pin (4, 5; 7,8) and/or a signal pin (1; 2; 3, 6) are used for carrying power from the device (62) to the radio-communication-stick (62).

13. RJ45-connector, comprising a jack (70) with pins (J1-J8) as part of a device (62) such as industrial automation device with embedded communication connectivity module (66) and/or industrial automation device processor (80), a corresponding plug with pins (P1-P8), wherein the plug (94) is part of a memory-stick which comprise an embedded memory.
